(19) United States
(12) Patent Application Publication
(10) Pub. No.: US 2024/0254293 A1
(43) Pub. Date: Aug. 1, 2024

(54) HIGHLY CROSSLINKED POLYMER PARTICULATE AND METHODS OF MANUFACTURING HIGHLY CROSSLINKED POLYMER PARTICULATE

(71) Applicant: EXXONMOBIL TECHNOLOGY AND ENGINEERING COMPANY, Spring, TX (US)

(72) Inventors: Alan A. GALUSKA, Huffman, TX (US); Pavlin B. ENTCHEV, Spring, TX (US); William HANDY, Spring, TX (US); Robert M. SHIRLEY, The Woodlands, TX (US)

(21) Appl. No.: 18/435,513

(22) Filed: Feb. 7, 2024

Related U.S. Application Data
(62) Division of application No. 16/938,467, filed on Jul. 24, 2020.
(60) Provisional application No. 62/888,214, filed on Aug. 16, 2019.
(60) Provisional application No. 62/944,106, filed on Dec. 5, 2019.
(60) Provisional application No. 62/949,302, filed on Dec. 17, 2019.
(60) Provisional application No. 62/890,188, filed on Aug. 22, 2019.

(51) Int. Cl. C08J 3/24; B29C 48/04; B29K 23/00; B29K 509/08; C08K 3/04; C08K 3/08; C08K 3/34; C08K 3/36; C08K 7/14; C08L 23/06

(52) U.S. Cl. CPC C08J 3/24; B29C 48/04; C08K 3/04; C08K 3/08; C08K 3/34; C08K 3/36; C08K 7/14; C08L 23/06; B29K 2023/0691; B29K 2509/08; C08J 2323/06; C08L 2205/14

(57) ABSTRACT

Highly crosslinked polymer particulate and methods of manufacturing highly crosslinked polymer particulate. The highly crosslinked polymer particulate includes a plurality of crosslinked polymer granules. Each crosslinked polymer granule includes a highly crosslinked polymeric material and a property-modifying filler. The highly crosslinked polymeric material includes a plurality of polyethylene polymer chains and a plurality of chemical crosslinks. The the plurality of chemical crosslinks includes chemical crosslinks that covalently bond a given polyethylene polymer chain of the plurality of polyethylene polymer chains to another polyethylene polymer chain of the plurality of polyethylene polymer chains. The property-modifying filler is configured to modify at least one property of the plurality of crosslinked polymer granules. A characteristic dimension of each crosslinked polymer granule of the plurality of crosslinked polymer granules is at least 10 micrometers and at most 5 millimeters.

### CROSS-REFERENCE TO RELATED APPLICATIONS

The current application is a divisional of U.S. patent application Ser. No. 16/938,467, entitled “Highly Crosslinked Polymer Particulate and Methods of Manufacturing Highly Crosslinked Polymer Particulate” (“the parent application”). The parent application also claims the benefit of U.S. Provisional Application 62/888,214 filed Aug. 16, 2019 entitled “Crosslinked Granular Polyethylene and U.S. Provisional Application 62/944,106 filed Dec. 5, 2019 entitled “Highly Crosslinked Polymer Particulate.” The parent application also claims the benefit of US. Provisional Application 62/949,302 filed Dec. 17, 2019 entitled “Highly Crosslinked Polymer Particulate and Methods of Manufacturing Highly Crosslinked Polymer Particulate”, and also claims the benefit of U.S. Provisional Application 62/890,188 filed Aug. 22, 2019 entitled “Granular Crosslinked Polyethylene as a Density Modifier in a Wellbore Operation Fluid Mixture” the entireties of which are incorporated by reference herein. The parent application is also related to co-pending U.S. Provisional Application 62/888,221 filed Aug. 16, 2019 entitled “Method of Manufacturing Crosslinked Granular Polyethylene”, the entirety of which is incorporated by reference herein. The parent application is also related to co-pending U.S. Provisional Application 62/890,185 filed Aug. 22, 2019 entitled “Granular Crosslinked Polyethylene as a Hydraulic Fracturing Proppant”, the entirety of which is incorporated by reference herein. The parent application is also related to co-pending U.S. Provisional Application 62/890,186 filed Aug. 22, 2019 entitled “Granular Crosslinked Polyethylene as a Loss Circulation Material in a Wellbore Operation Fluid”, the entirety of which is incorporated by reference herein. The parent application is also related to co-pending U.S. Provisional Application 62/904,993 filed Sep. 24, 2019 entitled “Granular Crosslinked Polyethylene as a Density Modifier in a Wellbore Operation Fluid Mixture”, the entirety of which is incorporated by reference herein.

### FIELD OF THE DISCLOSURE

The present disclosure relates generally to highly crosslinked polymer particulate and to methods of manufacturing the highly crosslinked polymer particulate, and more specifically to highly crosslinked polymer particulate and/or associated methods that include, utilize, and form crosslinked polyethylene.

### BACKGROUND OF THE DISCLOSURE

Polyethylene exhibits chemical and/or material properties that cause it to be widely utilized in industry. While suitable for many applications, polyethylene may be relatively soft, may be flexible, and/or may flow when subject to stress, especially at elevated temperatures. In addition, two polyethylene bodies, when brought into contact with one another under conditions of high stress and/or high temperature, may agglomerate. This softness, flow, and/or agglomeration of conventional polyethylene may be undesirable for certain applications, where materials with a greater hardness, a lower propensity for flow, and/or a decreased potential for agglomeration may be desirable. Thus, there exists a need for highly crosslinked polymer particulate.

### SUMMARY OF THE DISCLOSURE

Highly crosslinked polymer particulate and methods of manufacturing highly crosslinked polymer particulate. The highly crosslinked polymer particulate includes a plurality of crosslinked polymer granules. Each crosslinked polymer granule includes a highly crosslinked polymeric material and a property-modifying filler. The highly crosslinked polymeric material includes a plurality of polyethylene polymer chains and a plurality of chemical crosslinks. The plurality of chemical crosslinks includes chemical crosslinks that covalently bond a given polyethylene polymer chain of the plurality of polyethylene polymer chains to another polyethylene polymer chain of the plurality of polyethylene polymer chains. The property-modifying filler is configured to modify at least one property of the plurality of crosslinked polymer granules. A characteristic dimension of each crosslinked polymer granule of the plurality of crosslinked polymer granules is at least 10 micrometers and at most 5 millimeters.

The methods include combining a granular polymeric material, which includes a plurality of polyethylene polymer chains, and a property-modifying filler to form a material-filler mixture. The methods also include crosslinking the granular polymeric material, within the material-filler mixture, with a crosslinking apparatus to form a highly crosslinked polymeric material. The highly crosslinked polymeric material may include a plurality of chemical crosslinks. The plurality of chemical crosslinks includes chemical crosslinks that covalently bond a given polyethylene polymer chain of the plurality of polyethylene polymer chains to another polyethylene polymer chain of the plurality of polyethylene polymer chains. The methods further include forming a plurality of crosslinked polymer granules that include the highly crosslinked polymeric material. A characteristic dimension of each crosslinked polymer granule of the plurality of crosslinked polymer granules may be at least 10 micrometers and at most 5 millimeters. Each crosslinked polymer granule of the plurality of crosslinked polymer granules may include a fraction of the highly crosslinked polymeric material and also a fraction of the property-modifying filler. The property-modifying filler may be configured to modify at least one property of the plurality of crosslinked polymer granules.

### BRIEF DESCRIPTION OF THE DRAWINGS

FIG. 1 is a schematic illustration of examples of a highly crosslinked polymer particulate containing crosslinked polymer granules according to the present disclosure.

FIG. 2 is a flowchart depicting examples of methods of manufacturing highly crosslinked polymer particulate, according to the present disclosure.

FIG. 3 is a schematic illustration of examples of a system that may be utilized to perform the methods of FIG. 2.

FIG. 4 is a schematic illustration of examples of an extrusion apparatus that may be utilized during manufacture of highly crosslinked polymer particulate, according to the present disclosure.

FIG. 5 is a schematic illustration of examples of an electron beam irradiation system that may be utilized during manufacture of highly crosslinked polymer particulate, according to the present disclosure.

### DETAILED DESCRIPTION AND BEST MODE OF THE DISCLOSURE

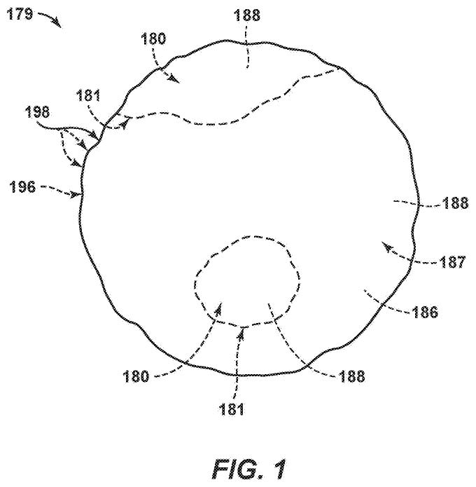

FIGS. 1-5 provide examples of highly crosslinked polymer particulate 179, of methods 400 of manufacturing highly crosslinked polymer particulate, of systems 104 for manufacturing highly crosslinked polymer particulate, and/or of extrusion apparatus 160 that may form a portion of systems 104, according to the present disclosure. Elements that serve a similar, or at least substantially similar, purpose are labeled with like numbers in each of FIGS. 1-5, and these elements may not be discussed in detail herein with reference to each of FIGS. 1-5. Similarly, all elements may not be labeled in each of FIGS. 1-5, but reference numerals associated therewith may be utilized herein for consistency. Elements, components, and/or features that are discussed herein with reference to one or more of FIGS. 1-5 may be included in and/or utilized with any of FIGS. 1-5 without departing from the scope of the present disclosure.

In general, elements that are likely to be included in a particular embodiment are illustrated in solid lines, while elements that are optional are illustrated in dashed lines. However, elements that are shown in solid lines may not be essential and, in some embodiments, may be omitted without departing from the scope of the present disclosure.

FIG. 1 is a schematic illustration of examples of a highly crosslinked polymer particulate 179 according to the present disclosure. Highly crosslinked polymer particulate 179 includes a plurality of crosslinked polymer granules 198. The plurality of crosslinked polymer granules each contains, or each crosslinked polymer granule of the plurality of crosslinked polymer granules contains, a polymeric material 186, which also may be referred to herein as a crosslinked polymeric material 186 and/or as a highly crosslinked polymeric material 186. The highly crosslinked polymeric material 186 includes a plurality of polyethylene polymer chains and a plurality of chemical crosslinks. The plurality of chemical crosslinks includes chemical crosslinks that covalently bond a given polyethylene polymer chain of the plurality of polyethylene polymer chains to another polyethylene polymer chain of the plurality of polyethylene polymer chains.

The plurality of crosslinked polymer granules 198 each also contains a property-modifying filler 180. The property-modifying filler 180 is configured to modify at least one property of the plurality of crosslinked polymer granules 198. This property modification may be relative and/or compared to a corresponding crosslinked polymer granule that includes the highly crosslinked polymeric material but that does not include the property-modifying filler. With this in mind, highly crosslinked polymer particulate 179 that includes property-modifying filler 180, according to the present disclosure, also may be referred to herein as a filled crosslinked polymer particulate 179, a filled highly crosslinked polymer particulate 179, a modified highly crosslinked polymer particulate 179, and/or a property-modified highly crosslinked polymer particulate 179. Property-modifying filler 180 additionally or alternatively may be referred to herein as a property-modifying material 180 and/or as property-modifying additive 180.

Property-modifying filler 180 may include any suitable material and/or materials that may modify, that may be configured to modify, and/or that may be selected to modify and/or to selectively modify the at least one property of the plurality of crosslinked polymer granules. Examples of the property-modifying filler include silica, talc, carbon black, a tracer material, a glass fiber, a metal, and/or another polymer (e.g., other than polyethylene). Examples of the tracer material include a radio frequency identification tag, a chemical tracer material that is chemically distinct from a remainder of the highly crosslinked polymer particulate, and/or a radioactive tracer material.

In some examples, the property-modifying filler may be distributed, may be uniformly distributed, and/or may be homogeneously distributed in and/or within each crosslinked polymer granule 198. In some examples, each crosslinked polymer granule 198 may include at least one property-modifying filler domain 181 and at least one highly crosslinked polymeric material domain 187. In some such examples, the at least one property-modifying filler domain and the at least one highly crosslinked polymeric material domain may be adhered to one another to form and/or define a corresponding crosslinked polymer granule. In some examples, the at least one highly crosslinked polymeric material domain may surround and/or encapsulate the at least one property-modifying filler domain. In some examples, the at least one property-modifying filler domain may surround and/or encapsulate the at least one highly crosslinked polymeric material domain. As indicated in dashed lines in FIG. 1, tracer material 188, when present, may be incorporated into and/or may form a portion of property-modifying filler domain 181 and/or crosslinked polymeric material domain 187.

It is within the scope of the present disclosure that the property-modifying filler may modify the at least one property of the plurality of crosslinked polymer granules. As an example, a composition of the property-modifying filler may be selected such that the at least one property of the plurality of crosslinked polymer granules is within a desired property range and/or such that the at least one property of the plurality of crosslinked polymer granules is greater or less than a corresponding property of the highly crosslinked polymeric material. As another example, a weight percentage of the property-modifying filler within the plurality of crosslinked polymer granules may be selected such that the at least one property of the plurality of crosslinked polymer granules is within the desired property range, such that the at least one property of the plurality of crosslinked polymer granules is greater than the corresponding property of the highly crosslinked polymeric material, or such that the at least one property of the plurality of crosslinked polymer granules is less than the corresponding property of the highly crosslinked polymeric material.

The at least one property of the plurality of crosslinked polymer granules may include and/or be any suitable, desired, and/or selected property of the plurality of crosslinked polymer granules. As examples, the at least one property of the plurality of crosslinked polymer granules may include one or more of a thermal stability of the plurality of crosslinked polymer granules, a glass transition temperature of the plurality of crosslinked polymer granules, a mechanical hardness of the plurality of crosslinked polymer granules, a mechanical strength of the plurality of crosslinked polymer granules, a Young's Modulus of the plurality of crosslinked polymer granules, a resistance to oil absorption of the plurality of crosslinked polymer granules, a traceability of detectability of the plurality of crosslinked polymer granules, a magnetic property of the plurality of crosslinked polymer granules, a chemical property of the plurality of crosslinked polymer granules, an electrical property of the plurality of crosslinked polymer granules, and/or a chemical reactivity of the plurality of crosslinked polymer granules. In such examples, the corresponding property of the highly crosslinked polymeric material may include and/or be a thermal stability of the highly crosslinked polymeric material, a glass transition temperature of the highly crosslinked polymeric material, a mechanical hardness of the highly crosslinked polymeric material, a mechanical strength of the highly crosslinked polymeric material, a Young's Modulus of the highly crosslinked polymeric material, a resistance to oil absorption of the highly crosslinked polymeric material, a traceability of detectability of the highly crosslinked polymeric material, a magnetic property of the highly crosslinked polymeric material, a chemical property of the highly crosslinked polymeric material, an electrical property of the highly crosslinked polymeric material, and/or a chemical reactivity of the highly crosslinked polymeric material.

As a more specific example, the at least one property of the plurality of crosslinked polymer granules may include and/or be a density of the plurality of crosslinked polymer granules. As an example, a composition of the property-modifying filler and/or a weight percentage of the property-modifying filler within the plurality of crosslinked polymer granules may be selected such that the density of the plurality of crosslinked polymer granules is within a desired density range. In some examples, the desired density range may be greater than a polymeric material density of the highly crosslinked polymeric material. Stated another way, a filler density of the property-modifying filler may be greater than the polymeric material density. In some examples, the desired density range may be less than the polymeric material density of the highly crosslinked polymeric material. Stated another way, the filler density may be less than the polymeric material density of the highly crosslinked polymeric material.

Examples of a lower bound, or limit, on the desired density range include a lower bound of at least 0.7 grams per cubic centimeter (g/cc), at least 0.75 g/cc, at least 0.8 g/cc, at least 0.85 g/cc, at least 0.9 g/cc, at least 0.95 g/cc, at least 1.0 g/cc, and/or at least 1.05 g/cc. Examples of an upper bound, or limit, on the desired density range include an upper bound of at most 2.0 g/cc, at most 1.9 g/cc, at most 1.8 g/cc, at most 1.7 g/cc, at most 1.6 g/cc, at most 1.5 g/cc, at most 1.4 g/cc, at most 1.3 g/cc, at most 1.2 g/cc, at most 1.1 g/cc, at most 1.0 g/cc, and/or at most 0.95 g/cc.

Examples of the polymeric material density include polymeric material densities of at least 0.85 g/cc, at least 0.86 g/cc, at least 0.87 g/cc, at least 0.88 g/cc, at least 0.89 g/cc, at least 0.9 g/cc, at least 0.91 g/cc, at least 0.92 g/cc, at least 0.93 g/cc, at least 0.94 g/cc, at least 0.95 g/cc, at most 0.96 g/cc, at most 0.97 g/cc, and/or at most 0.98 g/cc. Examples of the filler density include filler densities of at least 0.5 g/cc, at least 0.6 g/cc, at least 0.7 g/cc, at least 0.8 g/cc, at most 0.85 g/cc, at most 0.8 g/cc, and/or at most 0.75 g/cc. Additional and/or alternative examples of the filler density include filler densities of at least 2.0 g/cc, at least 2.1 g/cc, at least 2.2 g/cc, at least 2.3 g/cc, at least 2.5 g/cc, at least 3 g/cc, at least 3.5 g/cc, at most 9 g/cc, at most 8 g/cc, at most 7 g/cc, at most 6 g/cc, at most 5 g/cc, at most 4 g/cc, at most 3 g/cc, at most 2.75 g/cc, at most 2.5 g/cc, at most 2.25 g/cc, and/or at most 2 g/cc.

Each crosslinked polymer granule may have and/or define a corresponding granule density. In some examples, the corresponding granule density may be equal, or at least substantially equal, for each, or for every, crosslinked polymer granule. In some examples, a first subset of the plurality of crosslinked polymer granules may have and/or define a first granule density and a second subset of the plurality of crosslinked polymer granules may have and/or define a second granule density, which may differ from the first granule density.

The corresponding granule density of the plurality of crosslinked polymer granules may define, or may be referred to herein as defining, a granule density distribution. The granule density distribution may have and/or define any suitable distribution shape. Examples of the distribution shape include a constant distribution, an at least substantially constant distribution, a single-mode distribution, an at least substantially single-mode distribution, a multi-modal distribution, an at least substantially multi-modal distribution, a bimodal distribution, an at least substantially bimodal distribution, a trimodal distribution, an at least substantially trimodal distribution, a normal distribution, and/or an at least substantially normal distribution.

In some examples, the plurality of polyethylene polymer chains may include a plurality of linear polyethylene polymer chains. In some examples, each polyethylene polymer chain of the plurality of polyethylene polymer chains includes a plurality of methylene repeat units and/or a plurality of ethylene repeat units covalently bonded to one another to form a plurality of carbon-carbon bonds.

In some examples, at least a subset of the plurality of polyethylene polymer chains includes a branched polymer chain. The branched polymer chain may include at least one branch group, which may extend from a polymer backbone of the branched polymer chain. In some such examples, a given chemical crosslink of the plurality of chemical crosslinks may extend from the at least one branch group.

The at least one branch group, when present, may include any suitable number of carbon atoms and/or may have any suitable length. As examples, the at least one branch group may include at least 10, at least 25, at least 50, at least 100, at least 500, at least 1,000, at least 5,000, at least 10,000, at least 25,000, and/or at least 50,000 carbon atoms. The carbon atoms that form the at least one branch group may be arranged linearly, such as along a branch group backbone of the at least one branch group. Alternatively, the carbon atoms that form the at least one branch group may, themselves, form sub-branches. Stated another way, the at least one branch group may, itself, be branched.

In some examples, at least a subset of the plurality of polyethylene polymer chains includes a pendant group that extends from the polymer backbone of the subset of the plurality of polyethylene polymer chains. In some such examples, a given chemical crosslink of the plurality of chemical crosslinks may extend from the pendant group. The pendant group, when present, may include any suitable number of carbon atoms. As examples, the pendant group may include at least 1, at least 2, at least 3, at least 4, at least 5, at least 6, at least 7, at least 8, at least 10, at least 15, at least 20, at most 50, at most 40, at most 30, at most 20, at most 15, at most 12, at most 10, at most 8, and/or at most 6 carbon atoms.

The pendant group may have and/or define any suitable structure, including linear structures, branched structures, cyclic structures, and/or combinations thereof. A specific example of the pendant group includes pendant groups that may decrease, or limit, a degree of crosslinking of the plurality of crosslinked polymer granules, such as via increasing a minimum distance between adjacent polyethylene polymer chains and/or by making it difficult for the polymer backbones of adjacent polyethylene polymer chains to closely pack. Examples of such pendant groups include a methyl group, an ethyl group, a propyl group, a butyl group, a pentyl group, a hexyl group, a heptyl group, an octyl group, a nonyl group, and/or a decyl group.

In some examples, and prior to formation of the plurality of chemical crosslinks, the pendant group may include a ring, a cyclic structure, and/or a double bond, which may permit and/or facilitate formation of a corresponding chemical crosslink. Examples of such pendant groups include a cyclic hydrocarbon, a bridged cyclic hydrocarbon, a norbornene-derived pendant group, an ethylidene-derived pendant group, and/or a vinyl norbornene-derived pendant group.

The plurality of polyethylene polymer chains may be highly crosslinked via the plurality of chemical crosslinks. The plurality of polyethylene polymer chains may have and/or define any suitable degree of crosslinking, or average degree of crosslinking. Examples of the average degree of crosslinking include at least 0.01%, at least 0.1%, at least 1%, at least 2%, at least 3%, at least 4%, at least 5%, at least 6%, at least 8%, at least 10%, at least 12%, at least 14%, at least 16%, at least 18%, at least 20%, at least 25%, at least 30%, at least 35%, at least 40%, at least 45%, and/or at least 50%. In some examples, the highly crosslinked polymeric material within a given crosslinked polymer granule may be so highly crosslinked that the given crosslinked polymer granule may be defined by, at least substantially entirely by, or even entirely by a single polymeric molecule.

As used herein, the phrase “degree of crosslinking” may refer to a mole percentage, or an average mole percentage, of repeat units within a given polyethylene polymer chain that are crosslinked to another polyethylene polymer chain. For example, a polyethylene polymer chain with 100 repeat units and one crosslink would exhibit a “degree of crosslinking” of 1/100=1%. Similarly, a polyethylene polymer chain with 100 repeat units and 10 crosslinks would exhibit a “degree of crosslinking” of 10/100=10%.

Each chemical crosslink may extend from any suitable portion of a given polyethylene polymer chain to any suitable portion of another polyethylene polymer chain. For example, a chemical crosslink may extend from an ethylene repeat unit of a given polyethylene polymer chain to an ethylene repeat unit of another polyethylene polymer chain to form a covalent bond therebetween. As another example, for examples in which at least a subset of the plurality of polyethylene polymer chains includes a pendant group, a chemical crosslink may extend from a portion of a pendant group included in a given polyethylene polymer chain to a pendant group of another polyethylene polymer chain. Alternatively, the chemical crosslink may extend from a polymer backbone of a given polyethylene polymer chain to a pendant group of another polyethylene polymer chain.

In some examples, the plurality of chemical crosslinks may be distributed, evenly distributed, or even homogeneously distributed throughout the plurality of crosslinked polymer granules. Stated another way, and in these examples, the plurality of chemical crosslinks may be distributed throughout the plurality of crosslinked polymer granules.

In some examples, the plurality of chemical crosslinks may be heterogeneously distributed within each crosslinked polymer granule, such as when the plurality of chemical crosslinks is preferentially distributed proximate an external surface of each crosslinked polymer granule. Stated another way, each crosslinked polymer granule may include an external shell that exhibits a higher degree of crosslinking relative to a remainder of the crosslinked polymer granule.

The plurality of crosslinked polymer granules may have and/or define any suitable structure. As examples, the plurality of crosslinked polymer granules may include and/or be a plurality of high density polyethylene granules and/or a plurality of crosslinked high density polyethylene granules.

In addition, the plurality of crosslinked polymer granules may have and/or define any suitable shape. As examples, the plurality of crosslinked polymer granules may include a plurality of irregularly shaped crosslinked polymer granules, a plurality of spheroid-shaped crosslinked polymer granules, a plurality of at least partially spherical crosslinked polymer granules, a plurality of spherical crosslinked polymer granules, a plurality of at least partially cylindrical crosslinked polymer granules, a plurality of cylindrical crosslinked polymer granules, and/or a plurality of rod-shaped crosslinked polymer granules. In some examples, the plurality of crosslinked polymer granules may include polyethylene particles produced by a polyethylene reactor and subsequently crosslinked to form the plurality of crosslinked polymer granules.

The plurality of crosslinked polymer granules may include recycled polyethylene. As an example, the highly crosslinked polymer particulate, or the plurality of crosslinked polymer granules that comprise the highly crosslinked polymer particulate, may include at least a threshold fraction of a post-consumer granular polymeric material. Examples of the threshold fraction of the post-consumer granular polymeric material include 5 weight percent, 10 weight percent, 15 weight percent, 20 weight percent, 25 weight percent, 30 weight percent, 40 weight percent, 50 weight percent, 60 weight percent, 70 weight percent, 80 weight percent, 90 weight percent, 95 weight percent, 99 weight percent, and/or 100 weight percent.

A characteristic dimension of each crosslinked polymer granule is within a threshold characteristic dimension range of at least 10 micrometers and at most 5 millimeters. As more specific examples, a lower limit of the characteristic dimension range may be at least 10 micrometers, at least 15 micrometers, at least 20 micrometers, at least 25 micrometers, at least 30 micrometers, at least 40 micrometers, at least 50 micrometers, at least 75 micrometers, at least 100 micrometers, at least 125 micrometers, at least 150 micrometers, at least 200 micrometers, at least 250 micrometers, at least 300 micrometers, at least 400 micrometers, at least 500 micrometers, at least 600 micrometers, at least 700 micrometers, at least 800 micrometers, at least 900 micrometers, and/or at least 1,000 micrometers. Additionally or alternatively, an upper limit of the characteristic dimension range may be at most 5 millimeters, at most 3.5 millimeters, at most 3 millimeters, at most 2.5 millimeters, at most 2 millimeters, at most 1.5 millimeters, at most 1.25 millimeters, at most 1 millimeter, at most 900 micrometers, at most 800 micrometers, at most 700 micrometers, at most 600 micrometers, at most 500 micrometers, at most 400 micrometers, and/or at most 300 micrometers.

Examples of the characteristic dimension include a maximum extent of each crosslinked polymer granule and/or a diameter of each crosslinked polymer granule. Additional examples of the characteristic dimension include an effective diameter of each crosslinked polymer granule and/or a minimum diameter of a sphere that fully contains each crosslinked polymer granule.

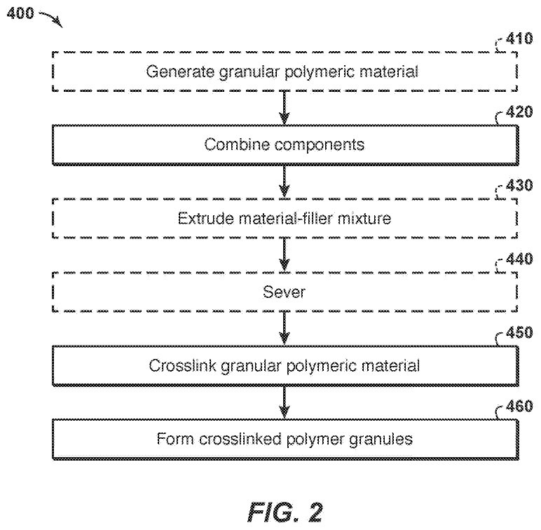

FIG. 2 is a flowchart depicting examples of methods 400 of manufacturing highly crosslinked polymer particulate, according to the present disclosure, such as highly crosslinked polymer particulate 179 of FIG. 1. Methods 400 may include generating a granular polymeric material at 410, and methods 400 include combining components at 420. Methods 400 also may include extruding a material-filler mixture at 430 and/or severing at 440, and methods 400 include crosslinking the granular polymeric material at 450 and forming a plurality of crosslinked polymer granules at 460.

Generating the granular polymeric material at 410 may include generating any suitable granular polymeric material, which may be utilized during the combining at 420 and/or during the crosslinking at 450, in any suitable manner. As an example, the generating at 410 may include severing a bulk polymeric material to produce and/or generate the granular polymeric material. Examples of the bulk polymeric material include a polymeric fiber, a polymeric film, a polymeric sheet, and/or an uncrosslinked polymer granule.

As another example, the granular polymeric material may include polyethylene pellets generated within a polyethylene reactor. Stated another way, and in this example, the generating at 410 may include generating the polyethylene pellets within the polyethylene reactor. In some such examples, the generating at 410 further may include selecting at least one property of a catalyst, which is utilized within the polyethylene reactor, such that a characteristic dimension of the granular polymeric material is within the threshold characteristic dimension range that is discussed herein with reference to crosslinked polymer granules 198 of FIG. 1.

The granular polymeric material may include polyethylene and/or a plurality of polyethylene polymer chains. The granular polymeric material may be uncrosslinked, or at least substantially uncrosslinked, during the generating at 410, prior to the combining at 420, during the combining at 420, and/or prior to the crosslinking at 450. In some examples, the granular polymeric material may include at least the threshold fraction of the post-consumer granular polymeric material, as discussed herein with reference to crosslinked polymer granules 198 of FIG. 1. In some examples, the granular polymeric material may, in addition to polyethylene, include an additional component. Examples of the additional component include another polymer, a colorant, an adhesive, a metal, a glass, alumina, and/or a silicate.

Combining components at 420 may include combining the granular polymeric material, which includes the plurality of polyethylene polymer chains, and a property-modifying filler to form, to produce, generate, and/or to define a material-filler mixture. The property-modifying filler may be configured to modify at least one property of the plurality of crosslinked polymer granules, as discussed herein. Examples of the property-modifying filler are disclosed herein with reference to property-modifying filler 180 of FIG. 1.

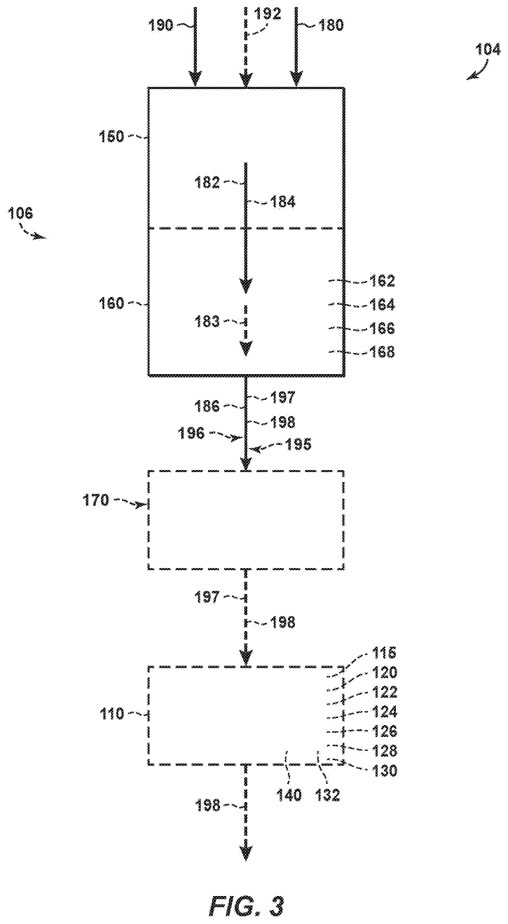

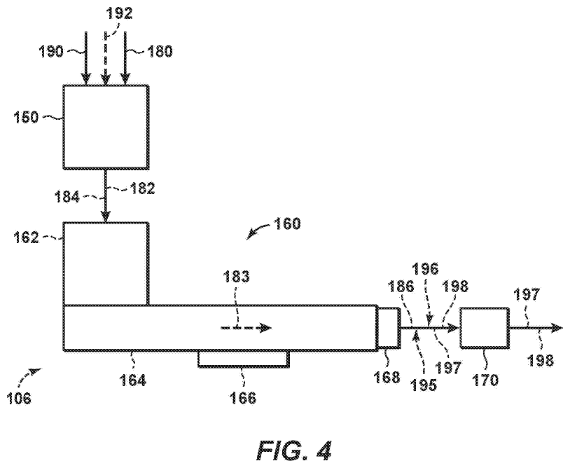

The combining at 420 may be accomplished in any suitable manner. As an example, the combining at 420 may include mixing the granular polymeric material with the property-modifying filler to form the material-filler mixture. As a more specific example, and as illustrated in FIGS. 3-4, the combining at 420 may include providing a granular polymeric material 190 and property-modifying filler 180 to a mixer 150, and the combining at 420 may be performed with, via, utilizing, and/or within the mixer such that the mixture produces and/or generates a material-filler mixture 182. As another more specific example, and with continued reference to FIGS. 3-4, a hopper 162 of an extrusion apparatus 160 may be utilized to form and/or define material-filler mixture 182. In such an example, the combining at 420 may include combining with, via, and/or utilizing the extrusion apparatus.

In some examples, methods 400 may be performed such that the plurality of crosslinked polymer granules, which are formed during the forming at 460, have and/or exhibit one or more desired properties. Stated another way, and as discussed herein, the property-modifying filler may modify at least one property of the plurality of crosslinked polymer granules. Examples of the at least one property of the plurality of crosslinked polymer granules are disclosed herein.

In a specific example, the at least one property of the plurality of crosslinked polymer granules includes a density of the plurality of crosslinked polymer granules. In this example, the combining at 420 may include combining such that the density of the plurality of crosslinked polymer granules is within a desired density range. This may be accomplished, for example, via control and/or regulation of a composition, a density, and/or a weight fraction of the property-modifying filler within the material-filler mixture. Stated another way, and as discussed herein with reference to crosslinked polymer granules 198 of FIG. 1, the composition, the density, and/or 20) the weight fraction of the property-modifying filler, within the material-filler mixture, may be selected, controlled, and/or regulated such that the density of the plurality of crosslinked polymer granules is within the desired density range. Examples of the desired density range are disclosed herein.

Each granule of the plurality of crosslinked polymer granules may have and/or define a corresponding granule density. In some examples, the combining at 420 may include combining such that the corresponding granule density is equal, or at least substantially equal, for each crosslinked polymer granule of the plurality of crosslinked polymer granules. Stated another way, the combining at 420 may be performed such that the granule density is homogeneous and/or constant for the plurality of crosslinked polymer granules and/or for all of the plurality of crosslinked polymer granules.

In some examples, the combining at 420 may include combining such that a first granule density of a first subset of the plurality of crosslinked polymer granules differs from a second granule density of a second subset of the plurality of crosslinked polymer granules. In some examples, the combining at 420 may include combining such the corresponding granule density of the plurality of crosslinked polymer granules defines a granule density distribution, examples of which are disclosed herein.

Extruding the material-filler mixture at 430 may include extruding the material-filler mixture with, via, utilizing, and/or within an extrusion apparatus, such as extrusion apparatus 160 of FIGS. 3-4. This may include heating the material-filler mixture to produce and/or generate a heated material-filler mixture, as indicated at 183 in FIGS. 3-4, and/or cooling the heated material-filler mixture to at least partially form an extruded polymeric material, as indicated at 195 in FIGS. 3-4, and/or to at least partially form the plurality of crosslinked polymer granules. The heating may include heating to a heated temperature that may be less than a melting temperature of the granular polymeric material. As examples, the heating temperature may be at least 10 degrees Celsius (° C.), at least 12° C., at least 14° C., at least 16° C., at least 18° C., at most 30° C., at most 28° C., at most 26° C., at most 24° C., at most 22° C., and/or at most 20° ° C.

The extrusion apparatus, when utilized, may include any suitable structure and/or structures. As an example, and as schematically illustrated in FIG. 3 and somewhat less schematically illustrated in FIG. 4, extrusion apparatus 160 may include hopper 162, which may be configured to contain the material-filler mixture. As another example, the extrusion apparatus may include a pressure-generation apparatus 164, such as a screw extruder, that may be configured to apply a pressure and/or a mechanical force to the material-filler mixture. As another example, the extrusion apparatus may include a heater 166, which may be configured to heat the material-filler mixture. As another example, the extrusion apparatus may include an extrusion die 186 that may include and/or define at least one aperture, and extruded polymeric material 195 may be produced from the aperture.

In some examples, the extruded polymeric material may have and/or define a characteristic dimension that is outside a threshold characteristic dimension range. In these examples, methods 400 further may include the severing at 440. The severing at 440 may include severing the extruded polymeric material to produce, to define, and/or to form a plurality of extruded polymer granules. The severing at 440 may include severing such that a characteristic dimension of the extruded polymer granules may be within a threshold characteristic dimension range, examples of which are disclosed herein.

In some examples, the extruding at 430 may include extruding such that the extruded polymeric material has and/or defines a characteristic dimension that is within the threshold characteristic dimension range. In these examples, methods 400 may not include, or may not be required to include, the severing at 440.

Crosslinking the granular polymeric material at 450 may include crosslinking the granular polymeric material, within the material-filler mixture, with a crosslinking apparatus, examples of which are disclosed herein. This may include crosslinking to form and/or to define a highly crosslinked polymeric material that includes a plurality of chemical crosslinks. The plurality of chemical crosslinks includes chemical crosslinks that covalently bond a given polyethylene polymer chain of the plurality of polyethylene polymer chains to another polyethylene polymer chain of the plurality of polyethylene polymer chains. Examples of the highly crosslinked polymeric material are disclosed herein.

Forming crosslinked polymer granules at 460 may include forming a plurality of crosslinked polymer granules that includes the highly crosslinked polymeric material. The plurality of crosslinked polymer granules has and/or exhibits a characteristic dimension that is within the characteristic dimension range disclosed herein. Additionally or alternatively, each crosslinked polymer granule of the plurality of crosslinked polymer granules may include a fraction of the highly crosslinked polymeric material and also a fraction of the property-modifying filler. Stated another way, the property-modifying filler may modify the at least one property of each crosslinked polymer granule of the plurality of crosslinked polymer granules.

In some examples, the extruding at 430 may be performed at least partially concurrently with the crosslinking at 450 and/or the crosslinking at 450 may be responsive to and/or a result of the extruding at 430. In these examples, the extrusion apparatus additionally or alternatively may be referred to herein as and/or may be a crosslinking apparatus that performs the crosslinking at 450, as indicated at 106 in FIGS. 3-4.

In some such examples, the combining at 420 further may include combining a crosslinking agent with the granular polymeric material and the property-modifying filler. In such examples, the combining at 420 may be utilized to generate a material-filler-agent mixture that includes the granular polymeric material, the property-modifying filler, and the crosslinking agent. Stated another way, and in such examples, the material-filler mixture further may include the crosslinking agent and also may be referred to herein as the material-filler-agent mixture. This is illustrated in FIGS. 3-4, with a crosslinking agent 192 also being provided to mixer 150 and/or to hopper 162 of extrusion apparatus 160 to produce and/or generate a material-filler-agent mixture 184.

In some such examples, the crosslinking at 450 may include performing the extruding at 430 by extruding the material-filler-agent mixture, such as within the extrusion apparatus. This may include extruding to produce and/or generate extruded polymeric material 195 in the form of an extruded highly crosslinked polymeric material 196 that includes a highly crosslinked polymeric material 186, as illustrated in FIGS. 3-4. In these examples, the combination of heat, pressure generated within the pressure-generating apparatus, and/or contact between the granular polymeric material and the crosslinking agent may cause the granular polymeric material to crosslink, within the extrusion apparatus, to form the extruded highly crosslinked polymeric material and/or to at least partially define the crosslinked polymer granules.

In some such examples, the extruding at 430 may include extruding such that the extruded highly crosslinked polymeric material defines the crosslinked polymer granules. Stated another way, and as illustrated in FIGS. 3-4, extruded highly crosslinked polymeric material 196 that is produced via extrusion apparatus 160 may form, directly form, define, and/or directly define crosslinked polymer granules 198.

In other such examples, the forming at 460 may include performing the severing at 440 to sever the extruded highly crosslinked polymeric material and to form and/or define the plurality of crosslinked polymer granules. Stated another way, the forming at 460 may be responsive to, may be a result of, and/or may be concurrent with the severing at 440. The severing at 440 may be accomplished in any suitable manner.

As examples, the severing at 440 may include cutting, grinding, chopping, and/or otherwise decreasing a characteristic dimension of the extruded highly crosslinked polymeric material such that the characteristic dimension of the plurality of crosslinked polymer granules is within the threshold characteristic dimension range. As another example, the severing at 440 may include providing extruded highly crosslinked polymeric material 196 to a severing apparatus 170, as illustrated in FIGS. 3-4. The severing apparatus may sever the extruded highly crosslinked polymeric material to produce and/or generate the plurality of crosslinked polymer granules 198.

When the combining at 420 includes combining to produce and/or generate the material-filler-agent mixture, the material-filler-agent mixture may include any suitable proportion, fraction, and/or percentage of the crosslinking agent. As examples, the material-filler-agent mixture may include at least 0.1 weight percent (wt %), at least 0.25 wt %, at least 0.5 wt %, at least 0.75 wt %, at least 1 wt %, at least 2 wt %, at least 4 wt %, at least 6 wt %, at least 8 wt %, and/or at least 10 wt % of the crosslinking agent.

The crosslinking agent may include and/or be any suitable chemical and/or compound that, when mixed and/or combined with the granular polymeric material and extruded within the extrusion apparatus, causes the granular polymeric material to crosslink. Examples of the crosslinking agent include a peroxide, an organic peroxide, di-(2,4-dichlorobenzoyl) peroxide, tert-butyl peroxybenzoate, 1,1-di-(tert-butylperoxy)-3,3,5-trimethylecyclohexane, dicumyl peroxide, tert-butyl cumyl peroxide, di-tert-butyl peroxide, 2,5-dimethyl-2,5-di(tert-butylperoxy)hexyne-3, 2,5-di(2-tert-butyl peroxyisopropyl)-benzene, 2,5-dimethyl-2,5-di(tert-butylperoxy)hexane, a silane, and/or an azo compound.

In some examples, the crosslinking at 450 may be performed subsequent to the extruding at 430. As an example, and as discussed, the extruding at 430 may include extruding the material-filler mixture, such as in the absence of the crosslinking agent, to form the extruded polymeric material. In such an example, methods 400 may include performing the severing at 440 to sever the extruded polymeric material and/or to form and/or define a plurality of extruded polymer granules. Also in such an example, the crosslinking at 450 may include crosslinking the plurality of extruded polymer granules, and the forming at 460 may be concurrent, or at least partially concurrent, with the crosslinking at 450.

As an example, and as illustrated in FIGS. 3-4, the extruding at 430 may be performed, within extrusion apparatus 160, to form and/or define extruded polymeric material 195, which may not be, or may not yet be, highly crosslinked. In some such examples, the extruding at 430 may include extruding such that extruded polymeric material 195 defines a plurality of extruded polymer granules 197. Stated another way, and as illustrated in FIGS. 3-4, extruded polymeric material 195 that is produced via extrusion apparatus 160 may form, directly form, define, and/or directly define extruded polymer granules 197.

In other such examples, methods 400 may include performing the severing at 440 to sever the extruded polymeric material and to form and/or define the plurality of extruded polymer granules. The severing at 440 may be accomplished in any suitable manner, examples of which are disclosed herein. As illustrated in FIGS. 3-4, the severing at 440 may include providing extruded polymeric material 195 to a severing apparatus 170. The severing apparatus may sever the extruded polymeric material to produce and/or generate the plurality of extruded polymer granules 197.

In some such examples, the crosslinking at 450 may include crosslinking the plurality of extruded polymeric granules to form and/or define the plurality of crosslinked polymer granules. In such examples, the forming at 460 may be concurrent with and/or a result of the crosslinking at 450.

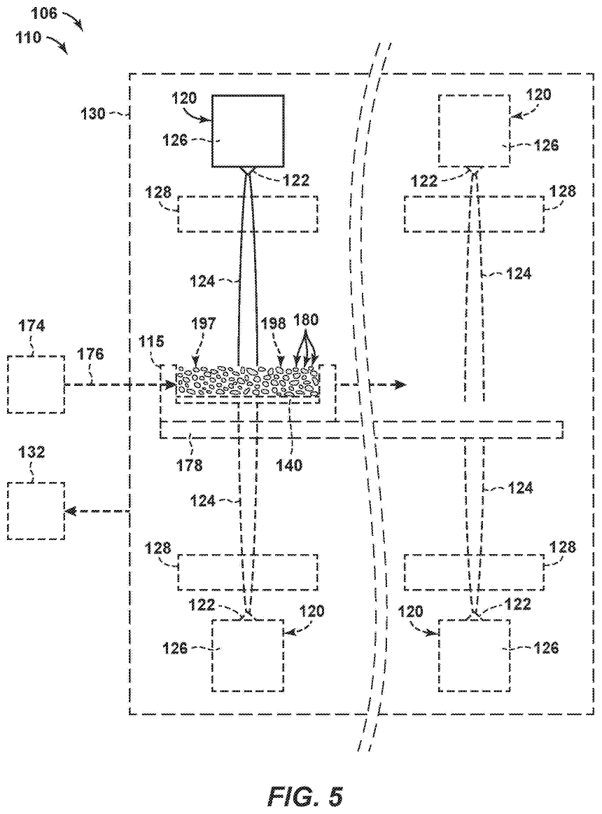

As an example, the crosslinking at 450 may include irradiating the extruded polymer granules with an electron beam to produce and/or facilitate formation of the plurality of crosslinked polymer granules. As an example, and as illustrated schematically in FIG. 3 and less schematically in FIG. 5, the crosslinking at 450 may include positioning extruded polymer granules 197 within a crosslinking apparatus 106 in the form of an electron beam irradiation system 110. In such examples, the crosslinking at 450 may include irradiating the extruded polymer granules with an electron beam 124. In the examples of FIGS. 3 and 5, electron beam 124 irradiates extruded polymer granules 197 to form and/or define crosslinked polymer granules 198. Also in the examples of FIGS. 3 and 5, extruded polymer granules 197 and/or crosslinked polymer granules 198 are contained within a granule holder 115.

The crosslinking apparatus may include an electron beam source, such as electron beam source 120 of FIGS. 3 and 5. The electron beam source may be configured to generate the electron beam, and the irradiating may include irradiating with the electron beam and/or with, via, and/or utilizing the electron beam source.

The electron beam source may include a filament, such as filament 122 of FIGS. 3 and 5. The filament may be configured to emit the electron beam. Under these conditions, the irradiating further may include applying an acceleration voltage to the filament to produce and/or to generate the electron beam. The acceleration voltage may be supplied by a power supply, such as power supply 126 of FIGS. 3 and 5. Examples of the power supply include a high voltage power supply, a variable voltage power supply, an alternating current power supply, and/or a direct current power supply.

The acceleration voltage may be selected to produce and/or to generate at least one desired mechanical property in the crosslinked polymer granules. Examples of the at least one desired mechanical property are disclosed herein. Additionally or alternatively, the acceleration voltage may be selected such that the electron beam penetrates, or fully penetrates, the extruded polymer granules. The presence of the property-modifying filler within the extruded polymer granules may cause an increase in the acceleration voltage needed to produce and/or generate this penetration, or full penetration when compared to extruded polymer granules that include the extruded polymeric material but that do not include the property-modifying filler. Examples of the acceleration voltage include acceleration voltages of at least 200 kilo-electron volts (keV), at least 400 keV, at least 600 keV, at least 800 keV, at least 1 mega-electron volt (MeV) at least 2 MeV, at least 4 MeV, at least 6 MeV, at least 8 MeV, at least 10 MeV, at most 20 MeV, at most 18 MeV, at most 16 MeV, at most 14 MeV, at most 12 MeV, at most 10 MeV, at most 8 MeV, at most 6 MeV, at most 4 MeV, at most 2 MeV, and/or at most 1 MeV.

The electron beam irradiation system may include a focus lens, such as focus lens 128 of FIGS. 3 and 5. An example of the focus lens includes a focus coil configured to generate an electric field and/or a magnetic field that interacts with and/or focuses the electron beam. The focus lens may be configured to focus the electron beam, such as on the extruded polymer granules, and the irradiating may include focusing the electron beam on the extruded polymer granules with, via, and/or utilizing the focus lens.

The electron beam irradiation system may include a vacuum chamber, such as vacuum chamber 130 of FIGS. 3 and 5. When the electron beam irradiation system includes the vacuum chamber, the crosslinking at 450 may include positioning the extruded polymer granules within the vacuum chamber, such as within granule holder 115 that may be positioned within the vacuum chamber. Also when the electron beam radiation system includes the vacuum chamber, and prior to the crosslinking at 450, methods 400 also may include evacuating the vacuum chamber. The evacuating may include evacuating with, via, and/or utilizing a vacuum pump, such as vacuum pump 132 of FIGS. 3 and 5. Examples of the vacuum pump include a gas transfer pump, a kinetic transfer pump, a positive displacement pump, and/or an entrapment pump.

The crosslinking at 450 also may include agitating the extruded polymer granules during the irradiating. As an example, the electron beam irradiation system may include an agitation apparatus, such as agitation apparatus 140 of FIGS. 3 and 5. Examples of the agitation apparatus include a rotating blade, a rotating screen, and/or a vibratory agitation apparatus. When the electron beam irradiation system includes the agitation apparatus, the agitating may include agitating with, via, and/or utilizing the agitation apparatus.

The agitating may increase and/or improve the crosslinking at 450. As an example, the agitating may increase a potential for complete exposure of the extruded polymer granules to the electron beam, may increase a potential for exposure of all sides of the extruded polymer granules to the electron beam, may increase an overall degree of crosslinking of the extruded polymer granules, and/or may provide deeper penetration, on average, of the electron beam into individual granules of the extruded polymer granules.

In some examples, the irradiating may include sequentially irradiating the extruded polymer granules utilizing a plurality of irradiation steps. In these examples, the agitating may include agitating the extruded polymer granules between at least two irradiation steps and/or even between each sequential pair of irradiation steps.

In some examples, and as illustrated in solid lines in FIG. 5, electron beam irradiation system 110 may include a single electron beam source 120. In such examples, the sequentially irradiating may include turning the single electron beam source 120 on and off a plurality of times, such as to permit the agitating to be performed between the irradiation steps and/or to permit extruded polymer granules 197 and/or crosslinked polymer granules 198 to cool between successive irradiation steps.

In some examples, and as illustrated in solid and in dashed lines in FIG. 5, electron beam irradiation system 110 may include a plurality of electron beam sources 120 that may be configured to concurrently and/or sequentially irradiate extruded polymer granules 197 and/or crosslinked polymer granules 198. As an example, and as illustrated on the left side of FIG. 5, a first electron beam source 120 may irradiate extruded polymer granules 197 and/or crosslinked polymer granules 198 from a top side thereof, and a second electron beam source 120 may irradiate extruded polymer granules 197 and/or crosslinked polymer granules 198 from a bottom side thereof.

As another example, electron beam irradiation system 110 may include a conveyance apparatus 178. Conveyance apparatus 178, when present, may be configured to operatively translate granule holder 115 such that electron beams 124 from different electron beam sources 120 may irradiate extruded polymer granules 197 and/or crosslinked polymer granules 198 during different time periods. In these examples, the sequentially irradiating may be performed by electron beams generated by different electron beam sources.

The crosslinking at 450 may include cooling the extruded polymer granules during the irradiating. When the irradiating includes irradiating via the plurality of irradiation steps, the cooling may include passively cooling the extruded polymer granules between successive irradiation steps. Additionally or alternatively, the cooling also may include actively cooling the extruded polymer granules. The actively cooling may be performed during the irradiating, subsequent to the irradiating, during the plurality of irradiation steps, and/or between successive irradiation steps. As an example, the cooling may include contacting the extruded polymer granules with a cooling fluid stream, such as cooling fluid stream 176 of FIG. 5, which may be provided by a cooling fluid source, such as cooling fluid source 174 of FIG. 5.

It is within the scope of the present disclosure that the irradiating, when performed, may include irradiating with any suitable beam dosage. As an example, the beam dosage may be selected to generate at least one desired mechanical property in the crosslinked polymer granules, examples of which are disclosed herein. As more specific examples, the beam dosage may include beam dosages of at least 1 megarads (Mrad), at least 5 Mrad, at least 10 Mrad, at least 15 Mrad, at least 20 Mrad, at least 30 Mrad, at least 40 Mrad, at least 60 Mrad, at least 80 Mrad, at least 100 Mrad, at least 150 Mrad, at least 200 Mrad, at least 300 Mrad, at least 400 Mrad, at least 500 Mrad, at least 750 Mrad, at least 10³ Mrad, at least 10⁴ Mrad, at least 10⁵ Mrad, at most 10⁶ Mrad, at most 10⁵ Mrad, at most 10⁴ Mrad, at most 10³ Mrad, at most 750 Mrad, at most 500 Mrad, at most 400 Mrad, at most 300 Mrad, at most 250 Mrad, at most 200 Mrad, at most 150 Mrad, and/or at most 100 Mrad.

As used herein, the phrase “highly crosslinked” may be utilized to modify and/or to describe polymeric material, polymer granules that are at least partially formed from the polymeric material, and/or polymer particulate that includes the polymer granules. Such polymeric material, polymer granules, and/or polymer particulate, when “highly crosslinked,” include polyethylene polymer chains with a degree of crosslinking sufficient to provide the highly crosslinked polymeric material, the highly crosslinked polymer granules, and/or the highly crosslinked polymer particulate with one or more of the below-described properties. Stated another way, a degree of crosslinking needed to provide the polymeric material, the polymer granules, and/or the polymer particulate with one or more of the below-described properties indicates that the polymeric material is a highly crosslinked polymeric material, that the polymer granules are highly crosslinked polymer granules, and/or the polymer particulate is a highly crosslinked polymer particulate in the context of the instant disclosure.

As an example, and upon fluid contact with naturally occurring liquid hydrocarbons, such as crude oil, within a hydrocarbon well, the highly crosslinked polymer particulate disclosed herein may undergo less than a threshold increase in mass due to absorption of the naturally occurring liquid hydrocarbons. Examples of the threshold increase in mass include threshold increases of 0.05%, 0.1%, 0.25%, 0.5%, 0.75%, 1%, 2%, 3%, 4%, and/or 5%.

As another example, and upon fluid contact with crude oil for a time period of 8 weeks, at a temperature of 85 degrees Celsius, and under a uniaxial stress of 35 Megapascals, the highly crosslinked polymer particulate disclosed herein undergoes at most a threshold increase in strain. Examples of the threshold increase in strain include increases of 1%, 2%, 3%, 4%, 5%, 6%, 8%, and/or 10%.

As yet another example, and when subjected to a confining stress of 42 Megapascals at a temperature of 85 degrees Celsius, a monolayer of the highly crosslinked polymer particulate disclosed herein defines at least a threshold fluid conductivity. Examples of the threshold fluid conductivity include fluid conductivities of 0.5×10⁴ micrometers³, 1.0×10⁴ micrometers³, 1.5×10⁴ micrometers³, 1.75×10⁴ micrometers³, 2×10⁴ micrometers³, 2.25×10⁴ micrometers³, 2.75×10⁴ micrometers³, 3×10⁴ micrometers³, 3.5×10⁴ micrometers³, 4×10⁴ micrometers³, 4.5×10⁴ micrometers³, 5×1⁰⁴ micrometers³, and/or 6×10⁴ micrometers³.

As another example, the highly crosslinked polymer particulate disclosed herein may have at least a threshold onset of melting temperature. Examples of the threshold onset of melting temperature include temperatures of 40 degrees Celsius, 45 degrees Celsius, 50 degrees Celsius, 55 degrees Celsius, 60 degrees Celsius, 65 degrees Celsius, 70 degrees Celsius, 75 degrees Celsius, 80 degrees Celsius, 85 degrees Celsius, 90 degrees Celsius, 95 degrees Celsius, 100 degrees Celsius, 105 degrees Celsius, and/or 110 degrees Celsius.

As yet another example, the highly crosslinked polymer particulate disclosed herein may have at least a threshold melting temperature. Examples of the threshold melting temperature include temperatures of 60 degrees Celsius, 65 degrees Celsius, 70 degrees Celsius, 75 degrees Celsius, 80 degrees Celsius, 85 degrees Celsius, 90 degrees Celsius, 95 degrees Celsius, 100 degrees Celsius, 105 degrees Celsius, 110 degrees Celsius, 115 degrees Celsius, 120 degrees Celsius, 125 degrees Celsius, 130 degrees Celsius, and/or 135 degrees Celsius.

As another example, the highly crosslinked polymer particulate disclosed herein may exhibit less than a threshold strain when subject to a stress of 35 Megapascals at a temperature of 85 degrees Celsius. Examples of the threshold strain include threshold strains of 40%, 39%, 38%, 37%, 36%, 35%, 34%, 33%, 32%, 31%, and/or 30%.

As yet another example, and when compared to an analogous uncrosslinked polymer particulate, the highly crosslinked polymer particulate disclosed herein may exhibit at least a threshold decrease in strain when subject to a stress of 35 Megapascals at a temperature of 85 degrees Celsius. Examples of the threshold decrease in strain include decreases of 10%, 9%, 8%, 7%, 6%, 5%, 4%, 3%, and/or 2%.

As used herein, the phrase “analogous uncrosslinked polymer particulate,” when utilized to compare to the highly crosslinked polymer particulate disclosed herein, may include an uncrosslinked polymer particulate that has and/or defines an identical chemical structure to that of the highly crosslinked polymer particulate with the exception that the uncrosslinked polymer particulate does not include the plurality of chemical crosslinks. Stated another way, a granular polymeric material may be crosslinked to form and/or define the highly crosslinked polymer particulate, and the analogous uncrosslinked polymer particulate may refer to the granular polymeric material prior to being crosslinked to form the highly crosslinked polymer particulate.

The highly crosslinked polymeric material, the highly crosslinked polymer granules, and/or the highly crosslinked polymer particulate disclosed herein may, in addition to one or more of the above-described properties, also, or optionally also, exhibit one or more of the below-described properties. As an example, the highly crosslinked polymer particulate may define a particulate density. Examples of the particulate density include densities of at least 0.8 grams per cubic centimeter (g/cc), at least 0.82 g/cc, at least 0.84 g/cc, at least 0.86 g/cc, at least 0.88 g/cc, at least 0.9 g/cc, at least 0.92 g/cc, at least 0.94 g/cc, at least 0.96 g/cc, at least 0.98 g/cc, at least 1 g/cc, at most 2.6 g/cc, at most 2.4 g/cc, at most 2.2 g/cc, at most 2 g/cc, at most 1.8 g/cc, at most 1.6 g/cc, at most 1.4 g/cc, at most 1.2 g/cc, at most 1.1 g/cc, at most 1 g/cc, at most 0.99 g/cc, at most 0.98 g/cc, at most 0.97 g/cc, and/or at most 0.96 g/cc.

As another example, and when compared to the analogous uncrosslinked polymer particulate, the highly crosslinked polymer particulate may resist fusing of the plurality of crosslinked polymer granules when exposed to a compressive force. Stated another way, fusing of the highly crosslinked polymer particulate may be quantitatively less than fusing of the analogous uncrosslinked polymer particulate. As examples, fusing of the highly crosslinked polymer particulate may be at least 10% less, at least 20% less, at least 30% less, at least 40% less, at least 50% less, at least 60% less, at least 70% less, at least 80% less, and/or at least 90% less than fusing of the analogous uncrosslinked polymer particulate when exposed to the compressive force.

As yet another example, and when compared to the analogous uncrosslinked polymer particulate, the highly crosslinked polymer particulate may resist flowing of the plurality of crosslinked polymer granules when exposed to the compressive force. Stated another way, the flow of the highly crosslinked polymer particulate may be quantitatively less than the flow of the analogous uncrosslinked polymer particulate. As examples, flow of the highly crosslinked polymer particulate may be at least 10% less, at least 20% less, at least 30% less, at least 40% less, at least 50% less, at least 60% less, at least 70% less, at least 80% less, and/or at least 90% less than the flow of the analogous uncrosslinked polymer particulate when exposed to the compressive force.

As another example, and when compared to the analogous uncrosslinked polymer particulate, the highly crosslinked polymer particulate may maintain fluid permeability among and/or between the plurality of crosslinked polymer granules when exposed to the compressive force. Stated another way, the fluid permeability of the highly crosslinked polymer particulate may decrease to a lesser extent when compared to fluid permeability of the analogous uncrosslinked polymer particulate. As examples, fluid permeability of the highly crosslinked polymer particulate may decrease at least 10% less, at least 20% less, at least 30% less, at least 40% less, at least 50% less, at least 60% less, at least 70% less, at least 80% less, and/or at least 90% less than the fluid permeability of the analogous uncrosslinked polymer particulate when exposed to the compressive force.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

### INDUSTRIAL APPLICABILITY

The systems and methods disclosed herein are applicable to industries that utilize polyethylene.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1-11. (canceled)

12. A method of manufacturing a highly crosslinked polymer particulate, the method comprising:
combining a granular polymeric material, which includes a plurality of polyethylene polymer chains, and a property-modifying filler to form a material-filler mixture;
crosslinking the granular polymeric material, within the material-filler mixture, with a crosslinking apparatus to form a highly crosslinked polymeric material that includes a plurality of chemical crosslinks, wherein the plurality of chemical crosslinks includes chemical crosslinks that covalently bond a given polyethylene polymer chain of the plurality of polyethylene polymer chains to another polyethylene polymer chain of the plurality of polyethylene polymer chains; and
forming a plurality of crosslinked polymer granules that includes the highly crosslinked polymeric material, wherein:
(i) a characteristic dimension of each crosslinked polymer granule of the plurality of crosslinked polymer granules is at least 10 micrometers and at most 5 millimeters;
(ii) each crosslinked polymer granule of the plurality of crosslinked polymer granules includes a fraction of the highly crosslinked polymeric material and also a fraction of the property-modifying filler; and
(iii) the property-modifying filler is configured to modify at least one property of the plurality of crosslinked polymer granules.

13. The method of claim 12, wherein the combining includes mixing the granular polymeric material with the property-modifying filler.

14. The method of claim 12, wherein the at least one property of the plurality of crosslinked polymer granules includes a density of the plurality of crosslinked polymer granules.

15. The method of claim 14, wherein the combining includes combining such that the density of the plurality of crosslinked polymer granules is within a desired density range.

16. The method of claim 12, wherein the combining includes extruding the material-filler mixture with an extrusion apparatus.

17. The method of claim 16, wherein the combining further includes combining the granular polymeric material, the property-modifying filler, and a crosslinking agent to form a material-filler-agent mixture, and further wherein the crosslinking includes extruding the material-filler-agent mixture.

18. The method of claim 17, wherein the crosslinking agent includes at least one of:
(i) a peroxide;
(ii) an organic peroxide;
(iii) di-(2,4-dichlorobenzoyl) peroxide;
(iv) tert-butyl peroxy benzoate;
(v) 1,1-di-(tert-butylperoxy)-3,3,5-trimethylecyclohexane;
(vi) dicumyl peroxide;
(vii) tert-butyl cumyl peroxide;
(viii) di-tert-butyl peroxide;
(ix) 2,5-dimethyl-2,5-di(tert-butylperoxy)hexyne-3;
(x) 2,5-di(2-tert-butyl peroxyisopropyl)-benzene;
(xi) 2,5-dimethyl-2,5-di(tert-butylperoxy)hexane;
(xii) a silane; and
(xiii) an azo compound.

19. The method of claim 17, wherein the extruding includes extruding to form an extruded highly crosslinked polymeric material, and further wherein the forming the plurality of crosslinked polymer granules includes severing the extruded highly crosslinked polymeric material to form the plurality of crosslinked polymer granules.

20. The method of claim 16, wherein the extruding includes extruding to form an extruded polymeric material, wherein the method further includes severing the extruded polymeric material to form a plurality of extruded polymer granules, wherein the crosslinking includes crosslinking the plurality of extruded polymeric granules, and further wherein the forming is concurrent with the crosslinking.

21. The method of claim 20, wherein the crosslinking includes irradiating the plurality of extruded polymer granules with an electron beam to facilitate formation of the plurality of crosslinked polymer granules.
